(19) United States
(12) Patent Application Publication
(10) Pub. No.: US 2020/0169760 A1
(43) Pub. Date: May 28, 2020

(54) SCENE CHANGE DETECTION AND HANDLING

(71) Applicant: ATI Technologies ULC, Markham (CA)

(72) Inventors: Jiao Wang, Markham (CA); Lei Zhang, Richmond Hill (CA); Ying Zhang, Markham (CA); Edward A. Harold, Markham (CA)

(73) Assignee: ATI Technologies ULC, Markham (CA)

(21) Appl. No.: 16/203,326

(22) Filed: Nov. 28, 2018

(51) Int. Cl. H04N 19/87; H04N 19/142; H04N 19/132; H04N 19/159; H04N 19/179; H04N 19/176

(52) U.S. Cl. CPC H04N 19/87; H04N 19/142; H04N 19/176; H04N 19/159; H04N 19/179; H04N 19/132

(57) ABSTRACT

Systems, methods, and devices for scene change detection and image encoding. A sequence of image frames is input. For a first image frame of the sequence, a first total sum of absolute transformed differences (SATD) is calculated. For a second frame of the sequence, a second total SATD is calculated. An absolute difference between the first total SATD and the second total SATD is calculated. If the absolute difference meets or exceeds a threshold, the second frame and a third frame of the sequence subsequent to the second frame are encoded based on a scene change, and the second frame and the third frame are transmitted. If the absolute difference does not meet or exceed the threshold, the second frame is encoded based on a same scene and the second frame is transmitted.

### BACKGROUND

A video frame that is part of the same scene as its preceding frame often includes much of the same visual information, with some differences. For example, the frames may have the same background and may include the same objects, where the objects move slightly from one frame to the next. Typical video compression techniques make use of this temporal relationship between successive frames in a stream by expressing each frame in terms of one or more neighboring frames. In effect, such techniques store or transmit only the differences between the frame and the preceding frame, where the complete frame is reconstructed based on its preceding frame and the differences between them. Storing or transmitting the differences requires fewer bits of information than storing or transmitting the complete frame.

When the scene changes in a video, the last frame of the prior scene and the first frame of the new scene often have a lesser temporal relationship than successive frames within a particular scene. For example, the first frame of a new scene may include a different background, and different objects. Accordingly, the differences between the two frames may be high enough that no significant reduction in the number of bits to store or transmit is possible based on intra-frame prediction techniques.

### BRIEF DESCRIPTION OF THE DRAWINGS

A more detailed understanding can be had from the following description, given by way of example in conjunction with the accompanying drawings wherein:

FIG. 1 is a block diagram of an example device in which one or more disclosed embodiments can be implemented;

FIG. 2 is a block diagram of the device of FIG. 1, illustrating additional detail;

FIG. 3 is a block diagram illustrating a graphics processing pipeline, according to an example;

FIG. 4 is a bar graph illustrating frame sizes for an example series of frames during which a scene change occurs;

FIG. 5 is a flow chart illustrating an example procedure for scene change detection and video compression;

FIG. 6 is a bar graph illustrating frame sizes for another example series of frames during which a scene change occurs; and

FIG. 7 is a block diagram illustrating example structures for implementing the techniques discussed herein.

### DETAILED DESCRIPTION

Some implementations provide a method for scene change detection and image encoding using a processor. A sequence of image frames is input to the processor. For a first image frame of the sequence, a first total sum of absolute transformed differences (SATD) is calculated in the processor. For a second frame of the sequence, a second total SATD is calculated in the processor. An absolute difference between the first total SATD and the second total SATD is calculated in the processor. If the absolute difference meets or exceeds a threshold, the second frame and a third frame of the sequence subsequent to the second frame are encoded in the processor based on a scene change, and the second frame and the third frame are transmitted. If the absolute difference does not meet or exceed the threshold, the second frame is encoded in the processor based on a same scene and the second frame is transmitted.

Some implementations provide a processor configured for scene change detection and image encoding. The processor includes circuitry to input a sequence of image frames; circuitry to calculate a first total sum of absolute transformed differences (SATD) or a first frame of the sequence; and circuitry to calculate a second total SATD for a second frame of the sequence. The processor includes circuitry to calculate an absolute difference between the first total SATD and the second total SATD. The processor also includes circuitry to encode the second frame and a third frame of the sequence subsequent to the second frame based on a scene change and transmit the second frame and the third frame if the absolute difference meets or exceeds a threshold; and circuitry to encode the second frame based on a same scene and transmit the second frame if the absolute difference does not meet or exceed the threshold.

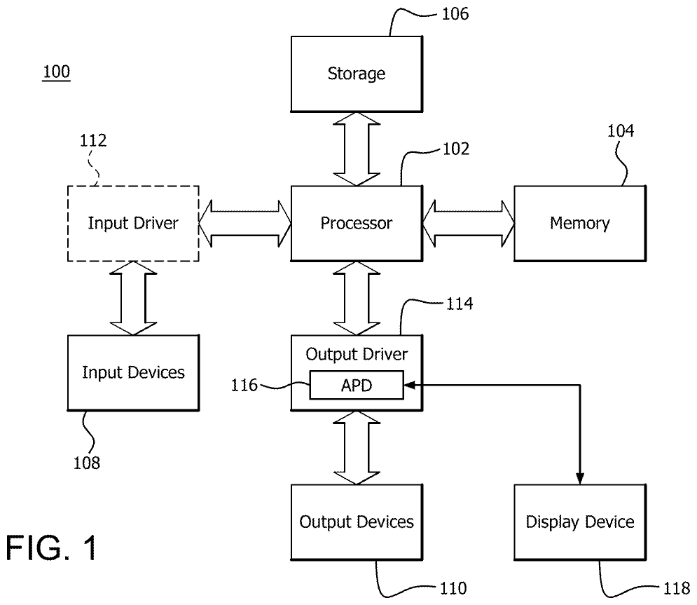

FIG. 1 is a block diagram of an example device 100 in which one or more features of the disclosure can be implemented. The device 100 could be one of, but is not limited to, for example, a computer, a gaming device, a handheld device, a set-top box, a television, a mobile phone, a tablet computer, or other computing device. The device 100 includes a processor 102, a memory 104, a storage 106, one or more input devices 108, and one or more output devices 110. The device 100 also includes one or more input drivers 112 and one or more output drivers 114. Any of the input drivers 112 are embodied as hardware, a combination of hardware and software, or software, and serve the purpose of controlling input devices 112 (e.g., controlling operation, receiving inputs from, and providing data to input drivers 112). Similarly, any of the output drivers 114 are embodied as hardware, a combination of hardware and software, or software, and serve the purpose of controlling output devices 114 (e.g., controlling operation, receiving inputs from, and providing data to output drivers 114). It is understood that the device 100 can include additional components not shown in FIG. 1.

In various alternatives, the processor 102 includes a central processing unit (CPU), a graphics processing unit (GPU), a CPU and GPU located on the same die, or one or more processor cores, wherein each processor core can be a CPU or a GPU. In various alternatives, the memory 104 is located on the same die as the processor 102, or is located separately from the processor 102. The memory 104 includes a volatile or non-volatile memory, for example, random access memory (RAM), dynamic RAM, or a cache.

The storage 106 includes a fixed or removable storage, for example, without limitation, a hard disk drive, a solid state drive, an optical disk, or a flash drive. The input devices 108 include, without limitation, a keyboard, a keypad, a touch screen, a touch pad, a detector, a microphone, an accelerometer, a gyroscope, a biometric scanner, an eye gaze sensor 530, or a network connection (e.g., a wireless local area network card for transmission and/or reception of wireless IEEE 802 signals). The output devices 110 include, without limitation, a display, a speaker, a printer, a haptic feedback device, one or more lights, an antenna, or a network connection (e.g., a wireless local area network card for transmission and/or reception of wireless IEEE 802 signals).

The input driver 112 and output driver 114 include one or more hardware, software, and/or firmware components that are configured to interface with and drive input devices 108 and output devices 110, respectively. The input driver 112 communicates with the processor 102 and the input devices 108, and permits the processor 102 to receive input from the input devices 108. The output driver 114 communicates with the processor 102 and the output devices 110, and permits the processor 102 to send output to the output devices 110. The output driver 114 includes an accelerated processing device (“APD”) 116 which is coupled to a display device 118. In some implementations, display device 118 includes a desktop monitor or television screen. In some implementations display device 118 includes a head-mounted display device (“HMD”), which includes screens for providing stereoscopic vision to a user. In some implementations the HMD also includes an eye gaze sensor for determining the direction in which the eye of a user is looking. The APD 116 is configured to accept compute commands and graphics rendering commands from processor 102, to process those compute and graphics rendering commands, and to provide pixel output to display device 118 for display. As described in further detail below, the APD 116 includes one or more parallel processing units configured to perform computations in accordance with a single-instruction-multiple-data (“SIMD”) paradigm. Thus, although various functionality is described herein as being performed by or in conjunction with the APD 116, in various alternatives, the functionality described as being performed by the APD 116 is additionally or alternatively performed by other computing devices having similar capabilities that are not driven by a host processor (e.g., processor 102) and configured to provide graphical output to a display device 118. For example, it is contemplated that any processing system that performs processing tasks in accordance with a SIMD paradigm may be configured to perform the functionality described herein. Alternatively, it is contemplated that computing systems that do not perform processing tasks in accordance with a SIMD paradigm performs the functionality described herein.

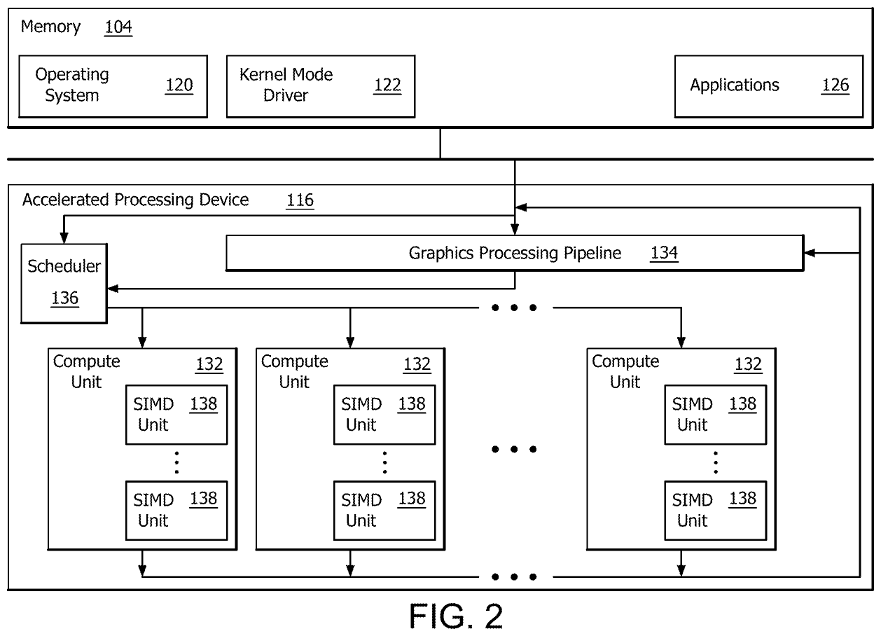

FIG. 2 illustrates details of the device 100 and the APD 116, according to an example. The processor 102 (FIG. 1) executes an operating system 120, a driver 122, and applications 126, and may also execute other software alternatively or additionally. The operating system 120 controls various aspects of the device 100, such as managing hardware resources, processing service requests, scheduling and controlling process execution, and performing other operations. The APD driver 122 controls operation of the APD 116, sending tasks such as graphics rendering tasks or other work to the APD 116 for processing. The APD driver 122 also includes a just-in-time compiler that compiles programs for execution by processing components (such as the SIMD units 138 discussed in further detail below) of the APD 116.

The APD 116 executes commands and programs for selected functions, such as graphics operations and non-graphics operations that may be suited for parallel processing. The APD 116 can be used for executing graphics pipeline operations such as pixel operations, geometric computations, and rendering an image to display device 118 based on commands received from the processor 102. The APD 116 also executes compute processing operations that are not directly related to graphics operations, such as operations related to video, physics simulations, computational fluid dynamics, or other tasks, based on commands received from the processor 102.

The APD 116 includes compute units 132 that include one or more SIMD units 138 that are configured to perform operations at the request of the processor 102 (or another unit) in a parallel manner according to a SIMD paradigm. The SIMD paradigm is one in which multiple processing elements share a single program control flow unit and program counter and thus execute the same program but are able to execute that program with different data. In one example, each SIMD unit 138 includes sixteen lanes, where each lane executes the same instruction at the same time as the other lanes in the SIMD unit 138 but can execute that instruction with different data. Lanes can be switched off with predication if not all lanes need to execute a given instruction. Predication can also be used to execute programs with divergent control flow. More specifically, for programs with conditional branches or other instructions where control flow is based on calculations performed by an individual lane, predication of lanes corresponding to control flow paths not currently being executed, and serial execution of different control flow paths allows for arbitrary control flow.

The basic unit of execution in compute units 132 is a work-item. Each work-item represents a single instantiation of a program that is to be executed in parallel in a particular lane. Work-items can be executed simultaneously (or partially simultaneously and partially sequentially) as a “wavefront” on a single SIMD processing unit 138. One or more wavefronts are included in a “work group,” which includes a collection of work-items designated to execute the same program. A work group can be executed by executing each of the wavefronts that make up the work group. In alternatives, the wavefronts are executed on a single SIMD unit 138 or on different SIMD units 138. Wavefronts can be thought of as the largest collection of work-items that can be executed simultaneously (or pseudo-simultaneously) on a single SIMD unit 138. “Pseudo-simultaneous” execution occurs in the case of a wavefront that is larger than the number of lanes in a SIMD unit 138. In such a situation, wavefronts are executed over multiple cycles, with different collections of the work-items being executed in different cycles. An APD scheduler 136 is configured to perform operations related to scheduling various workgroups and wavefronts on compute units 132 and SIMD units 138.

The parallelism afforded by the compute units 132 is suitable for graphics related operations such as pixel value calculations, vertex transformations, and other graphics operations. Thus in some instances, a graphics pipeline 134, which accepts graphics processing commands from the processor 102, provides computation tasks to the compute units 132 for execution in parallel.

The compute units 132 are also used to perform computation tasks not related to graphics or not performed as part of the “normal” operation of a graphics pipeline 134 (e.g., custom operations performed to supplement processing performed for operation of the graphics pipeline 134). An application 126 or other software executing on the processor 102 transmits programs that define such computation tasks to the APD 116 for execution.

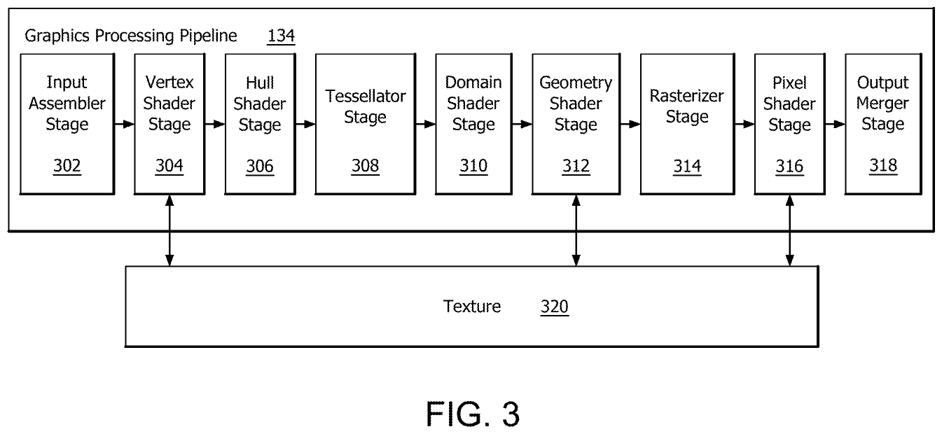

FIG. 3 is a block diagram showing additional details of the graphics processing pipeline 134 illustrated in FIG. 2. The graphics processing pipeline 134 includes stages that each performs specific functionality of the graphics processing pipeline 134. Each stage is implemented partially or fully as shader programs executing in the programmable compute units 132, or partially or fully as fixed-function, non-programmable hardware external to the compute units 132.

The input assembler stage 302 reads primitive data from user-filled buffers (e.g., buffers filled at the request of software executed by the processor 102, such as an application 126) and assembles the data into primitives for use by the remainder of the pipeline. The input assembler stage 302 can generate different types of primitives based on the primitive data included in the user-filled buffers. The input assembler stage 302 formats the assembled primitives for use by the rest of the pipeline.

The vertex shader stage 304 processes vertices of the primitives assembled by the input assembler stage 302. The vertex shader stage 304 performs various per-vertex operations such as transformations, skinning, morphing, and per-vertex lighting. Transformation operations include various operations to transform the coordinates of the vertices. These operations include one or more of modeling transformations, viewing transformations, projection transformations, perspective division, and viewport transformations, which modify vertex coordinates, and other operations that modify non-coordinate attributes.

The vertex shader stage 304 is implemented partially or fully as vertex shader programs to be executed on one or more compute units 132. The vertex shader programs are provided by the processor 102 and are based on programs that are pre-written by a computer programmer. The driver 122 compiles such computer programs to generate the vertex shader programs having a format suitable for execution within the compute units 132.

The hull shader stage 306, tessellator stage 308, and domain shader stage 310 work together to implement tessellation, which converts simple primitives into more complex primitives by subdividing the primitives. The hull shader stage 306 generates a patch for the tessellation based on an input primitive. The tessellator stage 308 generates a set of samples for the patch. The domain shader stage 310 calculates vertex positions for the vertices corresponding to the samples for the patch. The hull shader stage 306 and domain shader stage 310 can be implemented as shader programs to be executed on the compute units 132, that are compiled by the driver 122 as with the vertex shader stage 304.

The geometry shader stage 312 performs vertex operations on a primitive-by-primitive basis. A variety of different types of operations can be performed by the geometry shader stage 312, including operations such as point sprite expansion, dynamic particle system operations, fur-fin generation, shadow volume generation, single pass render-to-cubemap, per-primitive material swapping, and per-primitive material setup. In some instances, a geometry shader program that is compiled by the driver 122 and that executes on the compute units 132 performs operations for the geometry shader stage 312.

The rasterizer stage 314 accepts and rasterizes simple primitives (triangles) generated upstream from the rasterizer stage 314. Rasterization consists of determining which screen pixels (or sub-pixel samples) are covered by a particular primitive. Rasterization is performed by fixed function hardware.

The pixel shader stage 316 calculates output values for screen pixels based on the primitives generated upstream and the results of rasterization. The pixel shader stage 316 may apply textures from texture memory. Operations for the pixel shader stage 316 are performed by a pixel shader program that is compiled by the driver 122 and that executes on the compute units 132.

The output merger stage 318 accepts output from the pixel shader stage 316 and merges those outputs into a frame buffer, performing operations such as z-testing and alpha blending to determine the final color for the screen pixels.

Texture data, which defines textures, are stored and/or accessed by the texture unit 320. Textures are bitmap images that are used at various points in the graphics processing pipeline 134. For example, in some instances, the pixel shader stage 316 applies textures to pixels to improve apparent rendering complexity (e.g., to provide a more “photorealistic” look) without increasing the number of vertices to be rendered.

In some instances, the vertex shader stage 304 uses texture data from the texture unit 320 to modify primitives to increase complexity by, for example, creating or modifying vertices for improved aesthetics. In one example, the vertex shader stage 304 uses a height map stored in the texture unit 320 to modify displacement of vertices. This type of technique can be used, for example, to generate more realistic looking water as compared with textures only being used in the pixel shader stage 316, by modifying the position and number of vertices used to render the water. In some instances, the geometry shader stage 312 accesses texture data from the texture unit 320.

Video frames are typically compressed, e.g., to reduce the number of bits required to transmit the video in a given time period. This reduction in bits may be done in order to meet the bandwidth limitations of a transmission medium, for example. Such bandwidth-limited applications can impose a maximum bit rate for the video. This maximum bit rate can also be referred to as a “bit budget” for the video.

Various types of compression can be used to compress video frames. Typical classes of compression include intra-frame and inter-frame encoding. Intra-frame encoding identifies spatial redundancies within a frame to reduce the number of bits required to encode the frame. Intra-frame encoding can be used for an entire frame, or for only certain parts of the frame. Inter-frame encoding identifies temporal redundancies between the frame and temporally adjacent frames (or frames that are relatively close in time) to reduce the number of bits required to encode the frame. Inter-frame encoding can also be used for the entire frame, or for only certain parts of the frame.

Frames that are entirely encoded using intra-frame encoding can be referred to as intra-frames or I-frames. Certain types of I-frames that also include an indication that data used for intra-frame prediction at the receiver (e.g., a reference buffer that includes earlier frame data) should be cleared or invalidated can be referred to as instantaneous decoder-refresh (IDR) frames. Typically, I-frames are entirely encoded using intra-frame encoding.

Frames that are encoded using inter-frame encoding based on a previous frame can be referred to as inter-frames. Inter-frames that are encoded using forward prediction based on a previous (or preceding) frame can be referred to as P-frames. Inter-frames that are encoded using both forward and backward prediction based on both a previous (or preceding) frame and a subsequent (or later) frame can be referred to as bi-directionally predictive or B-frames. Inter-frame encoded frames can also include sections (e.g., macroblocks) that are encoded using intra-frame encoding. Each part (e.g., macroblock) of the inter-encoded frame can be encoded using a particular technique, which can be referred to as a mode.

If a scene change is encountered in a video, the first frame of the new scene will have an entirely different background, and/or different objects than the last frame of the old scene in some cases. More generally, in some cases, the first frame of the new scene will have few redundancies with the last frame of the old scene. Accordingly, the first frame of the new scene will not be significantly compressible using inter-frame encoding based on forward prediction from the last frame of the old scene. If the first frame of the new scene is encoded as an inter-frame using forward prediction based on the last frame of the old scene, it will include a significant number of portions that are encoded using inter-frame prediction. This will cause the size of the first frame of the new scene to be significantly larger than the last frame of the old scene.

If this increase in size is not expected and accounted for, the amount of the target bit rate remaining for transmission of the first frame of the new scene may be too low to transmit the frame at full size. Accordingly, the frame resolution may be reduced in order to transmit the frame at a lower size, decreasing image quality. Further, the second frame in the new scene may be encoded based on an assumed temporal relationship with the first frame. Since the first frame has been reduced in size (and accordingly, reduced in quality) however, the difference between the second frame and the first frame will also have a lesser temporal relationship, and lesser amount of potential compression, than would be the case if the first frame were not downscaled. Thus, the problem will propagate forward to successive frames, decreasing image quality.

In order to mitigate this effect, some approaches include techniques for detecting and accounting for a scene change. Some scene change detection techniques use a two-pass encoding approach. In two-pass encoding, an input frame (or a portion of the input frame; e.g., a macroblock) is encoded based on its temporal relationship with a previous frame. After encoding, the differences between the input frame and the previous frame (or portions thereof) are calculated. If the differences are determined to be above a threshold amount, the input frame is considered to be the first frame of a new scene. In this case, the input frame is encoded a second time as an I-frame (e.g., an IDR frame) using intra-frame compression only. It is noted that thresholds are discussed throughout with respect to one possible configuration for convenience, however any equivalent arrangement of the threshold (e.g., opposite sign, greater than, less than, greater than or equal to, less than or equal to, etc.) can be used.

Encoding a frame once as a P-frame and a second time as an I-frame in a two-pass approach increases the amount of processing time required to encode the frame over approaches where the frame is only encoded once. In some implementations, this can have the disadvantage of increasing latency and/or throughput, and accordingly, is unsuitable for real-time computer graphics applications in some implementations. Accordingly, some scene change detection techniques use a one-pass encoding approach.

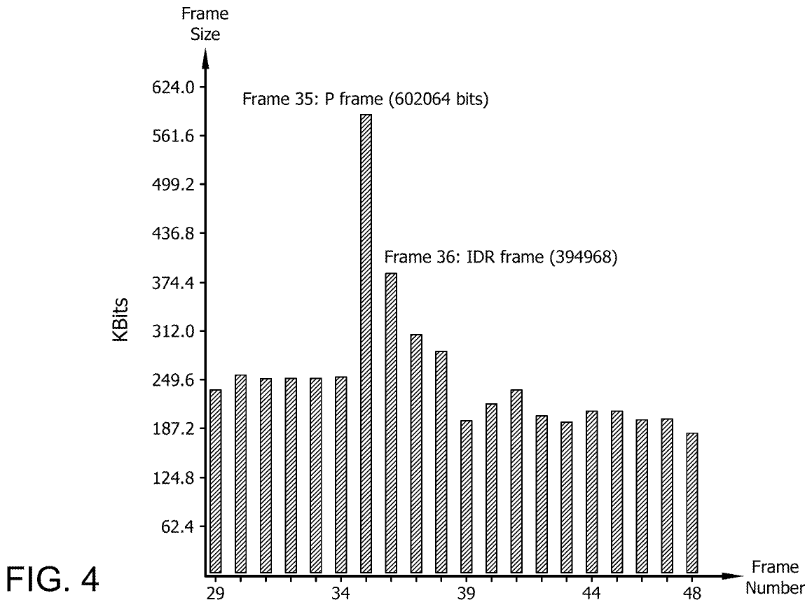

FIG. 4 is a bar graph illustrating frame sizes for an example series of frames during which a scene change occurs. In FIG. 4, scene change detection is performed using one-pass encoding. In this example, frame 35 is encoded as an inter-predictive frame (e.g., a P-frame); however frame 35 bears a significantly lower temporal relationship to frame 34 than the preceding frames bear to one another. Accordingly, while frame 35 is encoded as an inter-predictive frame, it is encoded with a significant number of intra-predictive blocks due to the lower temporal relationship. As illustrated in the graph, this causes the size of frame 35 to increase dramatically.

Frame 35 includes information regarding the prediction mode for each of its macroblocks. In frame 35, a significant number of macroblocks have been encoded using an inter-predictive mode. Accordingly, using the one-pass approach, the mode information is used to detect that a scene has changed in frame 35. Even assuming that this prediction is accurate, frame 35 has already been encoded as an inter-predictive frame however, and is not re-encoded in a one-pass approach.

Based on the prediction mode information in frame 35, the scene change is detected, and frame 36 is encoded as an intra-predictive frame (e.g., an IDR frame in this example).

Inter-predictive encoded frame 35 is significantly larger than the preceding frames due to its large number of intra-coded blocks. Accordingly, it consumes a larger amount of the bit budget for the video stream described in FIG. 4. Inter-predictive encoded frame 36 is also significantly larger than the preceding frames. Because frame 35 has already consumed a significant portion of the bit budget however, frame 36 must be reduced in quality in order to reduce its size and thus meet the bit budget.

In some implementations, this has the effect of reducing quality of both frame 35 and frame 36. Further, because subsequent frames (e.g., frame 37) include inter-predictive blocks based on frame 36, these frames will also be of lower quality as the prediction is based on the reduced quality frame 36.

As illustrated with respect to FIG. 4, some implementations of one-pass scene change detection can have the disadvantage of reduced frame quality following the scene change. Accordingly, some implementations provide one-pass scene change detection in a manner which mitigates reduced quality encoding following a scene change.

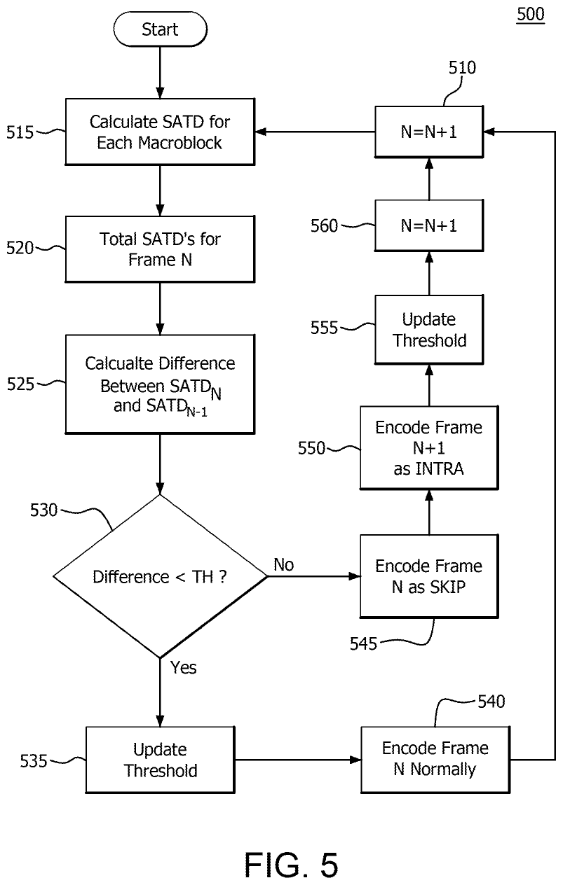

FIG. 5 is a flowchart illustrating an example scene detection procedure 500. Beginning from frame N=0 at step 505, a sum of absolute transformed differences (SATD) is calculated for each macroblock of frame N at step 515. Frames are divided into macroblocks for purposes of illustration in procedure 500, however other frame divisions are possible in some implementations. For example, in some implementations frames are divided into sub-macroblocks, or other partitions. In some implementations, the frame partitions (e.g., macroblocks) have an arbitrary size and structure. For example, in procedure 500 the macroblock may be subdivided into smaller blocks, e.g., for mode decision purposes. Example sizes of such subdivisions are 16×8, 8×16, 8×8, 8×4, 4×8 and 4×4.

As also exemplified by step 515, SATD is calculated for each partition (i.e., macroblock in this example) for purposes of illustration, however in some implementations, the sum of absolute differences (SAD) or sum of squared differences (SSD) is calculated for each partition. SATD is used throughout procedure 500 for ease of illustration.

In step 520, the calculated SATDs for all macroblocks of frame N are summed to calculate a total T_{SATD_N}. Equation 1 illustrates an example of this operation where frame N includes K macroblocks.

$${T\_SATD}_{N} = {\sum }_{i = 0}^{K} {SATD}_{i} \qquad Equation 1$$

In step 525, an absolute difference D_{N} is calculated between the total T_{SATD_N}, and the total of calculated SATDs for all macroblocks of the previous frame, T_{SATD_N-1} Equation 2 illustrates an example of this operation

D_{N}=|T_SATD_{N}−T_SATD_{N-1}| Equation 2:

The absolute difference D_{N} is compared with a threshold and on condition 530 that the absolute difference D_{N} is less than the threshold, the threshold is updated in step 535, and frame N is processed normally in step 540. The term “normally” in this case indicates that the frame N will be processed as inter or intra coded based on which approach provides the best performance (e.g., in terms of bit rate and/or distortion cost). In some implementations, the decision of which approach to use is determined by a mode decision module of the encoder, e.g., based on the bit rate and/or distortion cost, in some examples. The frame is advanced by one in step 510, and procedure 500 continues at 515 for the new frame.

In some implementations, the threshold can be weighted, e.g., to adjust the sensitivity of the scene change detection. Sensitivity is adjusted based on different use cases in some implementations. Equation 3 illustrates an example of the threshold comparison including a weight, where λ is the weighting term.

D_{N}<TH×λ Equation 3:

The threshold is initialized to a starting value at the beginning of the sequence. In some implementations, the initial value of the threshold is calculated based on the first two frames in the sequence. For example, in some implementations, the initial threshold, THᵢₙᵢₜᵢₐₗ, is calculated as the absolute value of the difference between the second frame total SATD (T_{SATD_1}) and the first frame total SATD (T_{SATD_0}) as illustrated in Equation 4.

THᵢₙᵢₜᵢₐₗ=|T_SATD₁−T_SATD₀| Equation 4:

In some implementations, λ is a constant. Example values of λ are 1.2 as a conservative value, or 1.5 as an aggressive value. In this context, the term conservative refers to a weighting value that results in a relatively more sensitive scene change detection (i.e., a scene change is detected more readily) while the term aggressive refers to a weighting value that results in a relatively less sensitive scene change detection (i.e., a scene change is detected less readily). In some implementations, λ is a non-constant, such as a pre-defined function. In some implementations, λ is set to 1 where it is not desired to weight the threshold. These values of λ are illustrative and used for convenience, however any suitable value of λ can be used. In some implementations, the value for λ is determined experimentally. In some implementations, λ is programmable and/or is dynamically adjustable.

Equation 5 illustrates the threshold update in step 535.

$$TH = \frac{TH \times ( N - 1 ) + {D}_{N}}{N} \qquad Equation 5$$

In this example, the terms N and N−1 take into account the overall frame count. It is noted that various other approaches to calculating the threshold TH are possible. For example, in some implementations, the threshold is based on a fixed number of recent frames (e.g., a “sliding window”). For example, setting the frame number window at 5, N=5 in equation 1 instead of the total number of encoded frames thus far. On condition 530 that the absolute difference D_{N} is not less than the threshold (or in some implementations, the weighted threshold), a scene change has been detected. Accordingly, frame N is processed as a skip frame in step 545, and frame N+1 is processed as an intra-coded frame (i.e., all blocks are intra-coded, i.e., without prediction based on frame N; e.g., as an IDR) in step 550. The threshold is updated in step 555. Equation 6 illustrates the threshold update in step 555:

TH=|T_SATD_{N+2}−T_SATD_{N+1}| Equation 6:

Stated another way, the threshold update is re-initialized as the absolute difference between the total of the SATDs in the intra-coded frame N+1, and the next following frame (i.e., at N+2). The updated threshold is calculated in other ways in some implementations.

The frame is advanced by one in step 560, advanced again by one in step 510, and procedure 500 continues at 515 for the new frame. Steps 510 and 560 are listed separately merely for ease of notation in the Figure. The frame is advanced by two frames in total in this conditional branch because two frames are encoded in steps 545 and 550. A scene change has already been detected relative to these frames. Accordingly, the next threshold measurement is between the intra-coded frame and the next following frame.

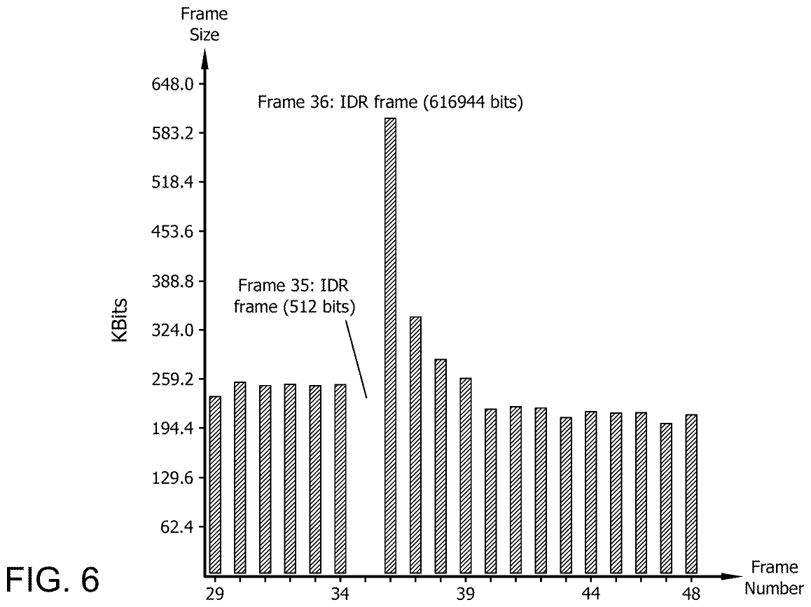

FIG. 6 is a bar graph illustrating frame sizes for an example series of frames during which a scene change occurs. FIG. 6 illustrates scene change detection performed based on an example implementation of the techniques discussed with respect to FIG. 5. In this example, as in FIG. 4, a scene change occurs at frame 35. Fame 35 is encoded as an inter-predictive frame (e.g., a P-frame); however frame 35 bears a significantly lower temporal relationship to frame 34 than the preceding frames bear to one another. Accordingly, while frame 35 is encoded as an inter-predictive frame, it is encoded with a significant number of intra-predictive blocks due to the lower temporal relationship.

Unlike FIG. 4 however, after encoding frame 35 as an inter-predictive frame (with a significant number of inter-coded blocks), frame 35 is determined to exceed a threshold for total SATD (e.g., as described with respect to condition 530 in FIG. 5). Instead of transmitting frame 35 as it was encoded, frame 35 is re-encoded as a skip frame (e.g., as described with respect to step 545 in FIG. 5). In this example, a skip frame includes only a header indicating that the frame includes no data and the previous frame (frame 34 in this example) should continue to be displayed.

Because a skip frame includes no image data, re-encoding frame 35 as a skip frame incurs a lower latency penalty than the two-pass techniques described earlier. Further, the skip frame also consumes significantly less of the overall bit budget for the stream than the one-pass techniques described earlier (e.g., with respect to FIG. 4.)

Based on the scene change detection, frame 36 is encoded as an infra-predictive frame (e.g., an IDR frame in this example). An intra-predictive frame 36 encoded at full quality would be significantly larger than the inter-predicted frames which preceded it. Because frame 35 is significantly smaller than the preceding frames however, frame 36 can be transmitted at a larger size than frame 36 as shown and described with respect to FIG. 4, because the bit budget remaining at frame 36 is significantly higher.

In some implementations, this has the effect of providing improved quality of both frame 35 and frame 36. Further, because subsequent frames (e.g., frame 37) include inter-predictive blocks based on frame 36, in some implementations, these frames will also be of higher quality than the corresponding frames as shown and described with respect to FIG. 4. At typical frame rates, repeating frame 34 in place of frame 35 (due to the skip frame) will be unnoticeable to the user in some implementations. Further, re-encoding frame 35 as a skip frame has a negligible impact on latency in some implementations due to its lack of data.

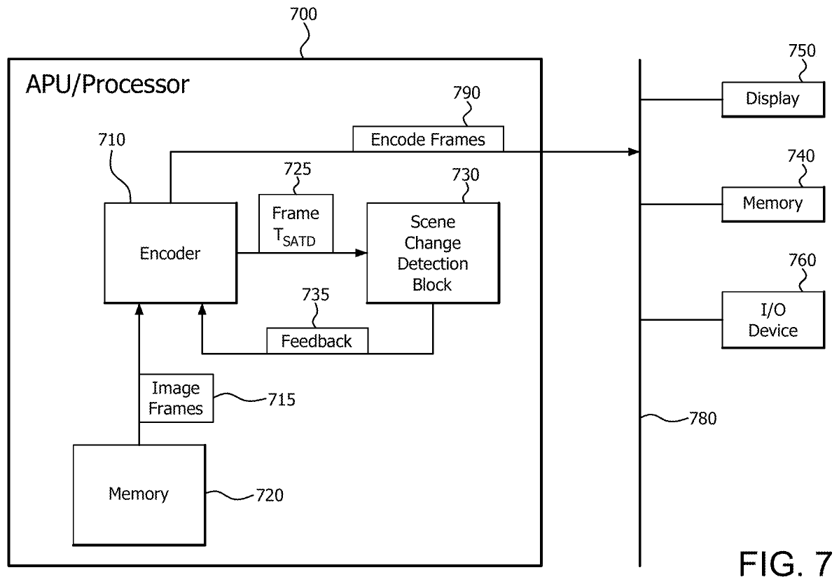

FIG. 7 is a block diagram illustrating example structures for implementing the techniques herein. Processor 700 includes an encoder 710, memory 720, and scene change detection block 730. The arrangement of processor 700 is exemplary. In some implementations, the various components of processor 700 are combined or their functions are divided among other components as desired.

In the example of FIG. 7, processor 700 is an APD similar to APD 116 as shown and described with respect to FIGS. 1-3. In some implementations, Processor 700 is a CPU, GPU, APU, or other suitable processing device. Processor 700 is configured to implement the example procedure shown and described with respect to FIG. 5. In some implementations, processor 700 is configured to implement a different suitable procedure for scene change detection and/or video compression.

In the example of FIG. 7, encoder 710 inputs a stream of image frames 715 from memory 720. In some implementations, encoder 710 inputs image frames from another source, such as memory 740, I/O device 760, or any other suitable source. In various implementations, memory 720 includes any suitable memory, such as a cache memory or buffer.

For each frame of the stream of image frames 715, encoder 710 calculates a total SATD 725, and communicates total SATD 725 to scene change detection block 730. In some implementations, the SATD or total SATD for the frame is calculated in the scene change detection block, or another suitable component of processor 700. In some implementations, these operations correspond to steps 515 and 520 as shown and described with respect to FIG. 5.

Scene change detection block 730 calculates an absolute difference between the total SATD and the total SATD of the previous frame. If the absolute difference is below a threshold (which may be a weighted threshold as discussed herein), the threshold is updated, e.g., as discussed herein, and feedback 735 is sent to encoder 710 indicating that encoder 710 should encode the frame normally. In some implementations, these operations correspond to steps 525, 530, 535, and 540 as shown and described with respect to FIG. 5. If the absolute difference is not below the threshold (or weighted threshold), feedback 735 is sent to encoder 710 indicating that encoder 710 should encode the frame as a skip frame, and should encode the next frame in the stream of image frames 715 as an intra-coded frame (e.g., an IDR frame). The threshold is also updated, e.g., as discussed herein. In some implementations, these operations correspond to steps 525, 530, 545, 550 and 555 as shown and described with respect to FIG. 5.

In either case, encoder 710 outputs encoded frames 790. In various implementations, encoded frames 790 are transmitted to any suitable consumer device in any suitable manner. For example, in some implementations, encoded frames 790 are transmitted over a computer communications medium 780 to a display device 750, memory 740, or I/O device 760.

It should be understood that many variations are possible based on the disclosure herein. Although features and elements are described above in particular combinations, each feature or element can be used alone without the other features and elements or in various combinations with or without other features and elements.

The methods provided can be implemented in a general purpose computer, a processor, or a processor core. Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors can be manufactured by configuring a manufacturing process using the results of processed hardware description language (HDL) instructions and other intermediary data including netlists (such instructions capable of being stored on a computer readable media). The results of such processing can be maskworks that are then used in a semiconductor manufacturing process to manufacture a processor which implements aspects of the embodiments.

The methods or flow charts provided herein can be implemented in a computer program, software, or firmware incorporated in a non-transitory computer-readable storage medium for execution by a general purpose computer or a processor. Examples of non-transitory computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for scene detection and image encoding using a processor, the method comprising:
inputting a sequence of image frames to the processor;
calculating, in the processor, for a first image frame of the sequence, a first total sum of absolute transformed differences (SATD);
calculating, in the processor, for a second frame of the sequence, a second total SATD;
calculating, in the processor, an absolute difference between the first total SATD and the second total SATD;
if the absolute difference meets or exceeds a threshold:
encoding, in the processor, the second frame and a third frame of the sequence subsequent to the second frame based on a scene change, and transmitting the second frame and the third frame; and
if the absolute difference does not meet or exceed the threshold:
encoding, in the processor, the second frame based on a same scene and transmitting the second frame.

2. The method of claim 1, wherein encoding the second frame based on a scene change comprises encoding the second frame as a skip frame.

3. The method of claim 1, wherein encoding the third frame based on a scene change comprises encoding the third frame as an intra-coded frame.

4. The method of claim 1, wherein encoding the third frame based on a scene change comprises encoding the third frame as an instantaneous decoder-refresh (IDR) frame.

5. The method of claim 1, wherein encoding the second frame based on the same scene comprises encoding the second frame as an inter-coded frame.

6. The method of claim 1, wherein encoding the second frame based on the same scene comprises encoding the second frame as an intra-coded frame or an inter-coded frame selectively based on performance.

7. The method of claim 1, wherein the first frame comprises a plurality of macroblocks, and the first total SATD is calculated by calculating a SATD for each macroblock and summing the macroblock SATDs.

8. The method of claim 1, wherein if the absolute difference does not meet or exceed the threshold, updating the threshold as
$$TH = \frac{TH \times ( N - 1 ) + {D}_{N}}{N} . ,$$
where:
TH is the threshold,
N is a sequence number of the current frame, and
D_{N} is the absolute difference between the first total SATD and the second total SATD.

9. The method of claim 1, wherein if the absolute difference meets or exceeds the threshold, updating the threshold to equal an absolute value of the difference between the second frame total SATD and the first frame total SATD.

10. The method of claim 1, wherein the threshold is weighted by a programmable constant.

11. A processor configured for scene change detection and image, comprising:
circuitry configured to input a sequence of image frames;
circuitry configured to calculate, for a first frame of the sequence, a first total sum of absolute transformed differences (SATD);
circuitry configured to calculate, for a second frame of the sequence, a second total SATD;
circuitry configured to calculate an absolute difference between the first total SATD and the second total SATD;
circuitry configured to, if the absolute difference meets or exceeds a threshold:
encode the second frame and a third frame of the sequence subsequent to the second frame based on a scene change and transmit the second frame and the third frame; and
if the absolute difference does not meet or exceed the threshold:
encode the second frame based on a same scene and transmit the second frame.

12. The processor of claim 11, wherein encoding the second frame based on a scene change comprises encoding the second frame as a skip frame.

13. The processor of claim 11, wherein encoding the third frame based on a scene change comprises encoding the third frame as an intra-coded frame.

14. The processor of claim 11, wherein encoding the third frame based on a scene change comprises encoding the third frame as an instantaneous decoder-refresh (IDR) frame.

15. The processor of claim 11, wherein encoding the second frame based on the same scene comprises encoding the second frame as an inter-coded frame.

16. The processor of claim 11, wherein encoding the second frame based on the same scene comprises encoding the second frame as an intra-coded frame or an inter-coded frame selectively based on performance.

17. The processor of claim 11, wherein the first frame comprises a plurality of macroblocks, and the first total SATD is calculated by calculating a SATD for each macroblock and summing the macroblock SATDs.

18. The processor of claim 11, wherein if the absolute difference does not meet or exceed the threshold, updating the threshold as
$$TH = \frac{TH \times ( N - 1 ) + {D}_{N}}{N} ,$$
where:
TH is the threshold,
N is a sequence number of the current frame, and
D_{N} is the absolute difference between the first total SATD and the second total SATD.

19. The processor of claim 11, wherein if the absolute difference meets or exceeds the threshold, updating the threshold to equal an absolute value of the difference between the second frame total SATD and the first frame total SATD.

20. The processor of claim 11, wherein the threshold is weighted by a programmable constant.
